(19) United States
(12) Patent Application Publication
(10) Pub. No.: US 2010/0196239 A1
(43) Pub. Date: Aug. 5, 2010

(54) CALCIUM AND/OR MAGNESIUM HYDROXIDE WITH VERY HIGH REACTIVITY, AND PREPARATION THEREOF

(75) Inventor: Philippe Dumont, St. Georges-sur-Meuse (BE)

Correspondence Address: HOVEY WILLIAMS LLP, 10801 Mastin Blvd., Suite 1000, Overland Park, KS, 66210, US

(73) Assignee: LIME TECHNOLOGY CONSULTING SPRL, Villers-le-Bouillet (BE)

(21) Appl. No.: 12/761,001

(22) Filed: Apr. 15, 2010

Related U.S. Application Data
(63) Continuation-in-part of application No. PCT/BE2008/000078, filed on Oct. 8, 2008.

(30) Foreign Application Priority Data
Oct. 19, 2007 (BE) 20070509
Aug. 4, 2009 (BE) 1017823

(51) Int. Cl. B01J 20/22; C01F 5/14; C09K 3/00; B01J 20/26; B01D 53/68; C01F 11/02; C08K 3/22

(52) U.S. Cl. 423/241; 423/635; 252/182.3; 502/401; 502/402; 252/194; 524/436

(57) ABSTRACT

Calcium hydroxide particles with very high reactivity exhibiting an X-ray diffraction line at d=0.49 nm obtained by the Debye-Scherrer powder method with an intensity below 50% of the intensity of a traditional hydrated lime with a specific surface area of 15.8 m²/g.

The present application is a continuation in part of PCT/BE2008/000078 filed on Oct. 8, 2008 and published on Apr. 23, 2009 under number WO2009/049382, claiming the priority of Belgian patent application BE2007/0509 filed on Oct. 19, 2007, now Belgian patent 1017823 granted on Aug. 4, 2009, the entire disclosures of which are incorporated herein by reference.

### FIELD OF THE INVENTION

The subject-matter of the present invention is a hydrated lime having very high reactivity in relation to the substances with which it reacts chemically in its manifold uses such as for example the treatment of water and gases, production of sand-lime materials, treatment of soils, manufacture of mineral paints (whitewashes), ceiling dressings, and masonry mortars.

Another subject-matter of the present invention is an economical process for the preparation of a particularly very high reactive calcium and/or magnesium hydroxide.

### STATE OF THE ART

Lime (other than lime used in metallurgy and the iron and steel industry, and in refractory materials) is used mainly in the form of calcium and/or magnesium hydroxide, either as a dry powder (hydrated lime) or in the presence of water as a paste (lime paste) or aqueous suspension (milk of lime or whitewash). Slaking of quicklime or dolomitic limestone is carried out in a factory process or through contact with materials containing a sufficient amount of water for its hydration, such as moist sand for the production of sand-lime materials, or in the treatment of moist soils in road construction.

Hydrated calcic and/or magnesian lime is an alkaline crystalline solid which is capable of reacting in acid-alkali type reactions only in the presence of water that will enable the lime to be solubilized and allow formation of (Ca++) ions and hydroxyl (OH−) ions.

However, lime is a material that is relatively poorly soluble in water, with concentrations of 1.85 g Ca(OH)₂/liter at 0° C. and 0.79 g/liter at 100° C. This limits its reactivity.

Attempts have been made to improve the chemical activity of this crystalline solid by modifying its physical properties such as its fineness and specific surface area in order to obtain faster and more complete reactions. These characteristics are combined under the more general attribute of “reactivity”.

Characterizing the reactivity of hydrated lime in terms of specific surface area and fineness without taking the morphology of the crystals into account does not allow a comprehensive definition to be given of the capability of the lime to react chemically with solid, liquid or gaseous substances.

For example, in reactions in aqueous phase, the fineness of the lime and the external surface area of the micelles will be a dominant factor because the surface tension of the liquid prevents liquid from circulating inside the micelles. Structure and morphology will also be of major importance.

The same is true of reactions between the hydrated lime and moist solids SU and claw in the production of sand-lime materials and for the stabilization on of clayey-oozy soils.

For reactions in gaseous phase and treatment of waste gases, the internal specific surface area of the hydrated lime is an important factor for the neutralization of acid gases, but the structure and morphology of the crystals are also important. These three parameters combine to define the “reactivity” of the lime in gas treatments, that is to say at least the kinetics of the reaction with the acid gases and the acid gas absorption factor.

As is well known, hydrated lime is formed through precipitation of the calcium and hydroxyl ions in solution with formation of nuclei or seeds of crystallization and growth of these nuclei or seeds in the form of crystals.

Numerous studies have revealed the morphology of calcium hydroxide crystals, a morphology defined by a hexagonal crystalline system in which the vertical crystallographic axis c is perpendicular to three coplanar axes a1, a2 and a3 of equal dimension, each separated by an angle of 120 degrees.

The conditions under which quicklime is slaked will determine the size, number, morphology and degree of crystallization of the crystals.

Thus, hydrated lime is made up of hexagonal prismatic plates whose thicknesses can vary according to the dimension of the c and a axes, and which are spaced apart by weak hydrogen bridges.

It is this structure that gives hydrated lime (among other characteristics) its plastic properties in paste form, due to the sliding of plates over each other.

As the spacing between plates is constant or nearly so, it follows that the volume of the voids is proportional to the specific surface area of the hydrate and inversely proportional to the thickness of the plates (c axis), as numerous investigators have confirmed.

Hence, unlike that in quicklime, the volume of the voids in hydroxides of calcium and magnesium consists not of cylindrical pores characterized by a sectional diameter but of spaces between plates.

The value of this spacing is constant or nearly so. It follows that the volume of the voids is proportional to the surface area of the plates and inversely proportional to their thickness per unit of weight.

This structure of hydrated limes has been revealed by optical and electronic microscopy in the course of a great many investigations by the cement industry research centers, as the calcium hydroxide (CH) Portlandite is an essential component (approximately 30%) of hydrated calcium silicates (CSH). In an article in Zement-Kalk-Gips (January 1994), W. Jozewicz and B. K. Gullet confirm the perfectly linear correlation between specific BET surface area (m²/g) and porosity both in commercial limes and in limes produced in the laboratory.

The use of a hydrated lime with very high reactivity offers many advantages and great economic benefits in manifold uses such as in water treatment, soil stabilization, production of autoclaved sand-lime materials, neutralization of waste gases, masonry and ceiling mortars, and whitewashes (mineral paints).

These applications generally use conventional hydrated lime obtained by reacting pulverized quicklime with a quantity of water that is approximately double the stoichiometric quantity so that the heat of reaction is eliminated by evaporation of excess water.

Even in the permanent presence of excess liquid water, local temperatures of reaction are higher than 100° C. in a CaO—Ca(OH)₂-liquid H₂O -gaseous H₂O system in disequilibrium due to the rapidity of the reactions.

Thus local reaction temperatures of between 110° C. and 135° C. are attained, causing the rapid formation of a large amount of steam.

The grain size of this traditional hydrated lime is between 2 and 90 microns with a high proportion of particles between 10 and 40 microns, and its specific surface area varies between 12 and 18 m²/g. The grains consist of calcium hydroxide in the form of large, highly crystalline crystals, as shown by the distinctness and intensity of the lines (lines d=0.49 nm) obtained by X-ray diffraction by the Debye-Scherrer method.

The powder method developed by Dehye and Scherrer consists in placing the finely divided sample, contained in a thin-walled capillary tube, at the center of a cylindrical chamber covered with X-ray film. An X-ray beam is projected on to the sample using the K-alpha line of copper.

The beams reflected by each series of lattice planes of the crystal produce a cone of diffused rays.

This cone intersecting the cylindrical film which surrounds the sample is the source of the lines observed.

The distance from each line to the center of the central spot is measured. From these measurements, calculation of the interval between planes makes it possible to identify the nature of the crystal in relation to known reference values with a reflected-lines value d=0.49 nm for Ca(OH)₂.

This qualitative analysis is applied with a view to evaluating the degree of crystallization of the calcium hydroxide. The intensity of the diffraction line (d=0.49 nm) increases with an increase in the degree of crystallization of the hydrate.

A scale of values has thus been established, with arbitrary units between 0 and 100. This method is used in mineral inorganic chemistry to evaluate the degree of crystallization of cements and other inorganic compounds.

These characteristics and this morphology give traditional lime a very low reactivity, with adverse consequences in its various applications as a chemical product or construction material.

Such traditional lime has low plasticity, a low rate of carbonatation in masonry and ceiling mortars, and a very low capacity to absorb acid gases.

The use of this traditional hydrated lime as whitewash or mineral lime paint reveals its low reactivity and its poor capacity to become carbonated in contact with the carbon dioxide in the air. This reaction, which requires the presence of moisture because the reagent is in the solid state, is so slow that the rate of drying outstrips the kinetics of the carbonatation reaction, resulting in very poor adhesion to the substrate, and in powdering.

The use of hydrated lime as a paste produced with a large excess of water, or of hydrated lime that is very fine, or, again, of hydrated lime with a large specific surface area, are all calculated to improve the adhesion of the whitewash to its substrate, but do not, however, attain the performance desired.

It is within the framework of this research that the product and manufacturing process of a hydrated lime with very high reactivity according to the invention have been discovered. Its applications range far beyond this field of application.

To remedy these major drawbacks, various processes have been proposed with a view to improving the physico-chemical properties of hydrated limes and their reactivity.

Thus, U.S. Pat. No. 2,309,168-2,365,736-2,409,546 propose that quicklime be hydrated under pressure to yield a fully hydrated lime with very high plasticity, with a view to making such lime suitable for forming mortars with very high workability.

The hydrated calcic and dolomitic limes thus formed are characterized by an Emley plasticity higher than 200 measured in accordance with standard ASTM C110-85, due to their large specific surface area and very high fineness.

The pressurized processes have been improved by U.S. Pat. No. 3,106,453 and U.S. Pat. No. 3,250,520 through the use of quicklime with very high reactivity that is calcined rapidly at low temperature.

Despite these improvements, the distinctness and intensity of the lines obtained by X-ray diffraction by the Debye-Scherrer method (Cu K-alpha radiation) show that the micelles of these limes are constituted by well-formed crystals.

This high degree of crystallization limits the reactivity of the solid. Another aspect of the pressurized hydration process is that it needs expensive equipment and considerably increases the production cost.

In U.S. Pat. No. 2,453,637 an effort has been made to improve the reactivity of the hydrates and in particular their plasticity by incorporating less than 3% by weight of carbonates or bicarbonates of sodium, potassium and magnesium into the hydrates under pressure.

Again with the aim of improving the quality of the hydrates, U.S. Pat. No. 2,956,867 prescribes fine pulverization to improve the plasticity of the hydrate.

U.S. Pat. No. 3,120,444 recommends the addition of aliphatic alcohols such as methanol, ethanol, polyvinylic alcohol, or glycerol, in proportions which are variable and lower than 10%.

According to U.S. Pat. No. 4,636,379, quicklime is hydrated at a temperature below 45° C. with a solution containing 30 to 50 parts by volume of water and 70 to 50 parts by volume of methanol which is then eliminated by evaporation. This process yields dry hydrates with a specific surface area of between 36 and 48 m²/g.

To produce very fine particles of calcium hydroxide with a high specific surface area, Patent DE 3620024 A1 proposes that 0.1 to 5.0% by weight of alcohol and sugar be added to the hydration water, and that the fluidity of the hydrate be improved by incorporating 0.1 to 5.0% by weight of glycol or amine.

In another process (EP 0558522 B1), the man skilled in the art has proposed that calcium and/or magnesium oxide be transformed into calcium and/or magnesium hydroxide by reacting an amount of water of between 0.6 and 2 parts by weight to one part of CaO and/or MgO in the presence of an additive selected among monoethylene glycol, diethylene glycol, triethylene glycol, monoethanolamine, diethanolamine, and triethanolamine, and mixtures thereof in an additives to CaO and/or MgO ratio by weight of more than 0.002:1.

The product obtained by this process exhibits a specific surface area greater than 35 m²/g and a moisture content below 50%.

Also known from the document U.S. Pat. No. 5,492,685 is a hydrated lime composed of particles with a specific surface area greater than 55 m²/g, an average diameter of less than 2.5 microns, and a pore volume greater than 0.25 cm³/g.

The process according to that patent recommends the hydration of a very reactive quicklime with a specific surface area of between 1.5 and 3.0 m²/g with a mixture of water and alcohol in amounts of 1 to 2 times the stoichiometric quantity of water and 2 to 3 volumes of alcohol per volume of water.

To characterize the reactivity of the lime, emphasis is placed on the specific surface area, pore volume, pore diameter, lime particle size, and crystal dimension.

Lastly, the document EP 0861209131 has disclosed a process of hydrating a pulverized quicklime of moderate reactivity (above 30° C./min) with an amount of water such that the hydrate contains 15 to 30% by weight of moisture, which is dried at a temperature below 500° C. to prevent the reverse dehydration reaction (Ca(OH)₂=>CaO+H₂O) and in the absence of CO₂ so as to prevent a carbonatation reaction (Ca(OH)₂+CO₂=>CaCO₃) and which is then pulverized to yield a dry, non-carbonated hydrated lime with a fraction of particle size distribution greater than 32 micron of between 20 and 50% by weight, a specific surface area greater than 30 m²/g, and a pore volume of at least 0.1 cm³/g.

All these processes have helped to improve the reactivity of hydrated limes by increasing the fineness of the particles and above all by providing finer hexagonal crystals of calcium hydroxide (c≦a) that have a larger specific surface area and a larger corresponding void volume.

However, despite these improvements, the thickness of the plates remains greater than 150 microns, which represents a very large number of Ca⁺⁺ and OH⁻ ions in relation to the dimensions of the elementary calcium hydroxide crystal described by Hedin (base 3.5844 Å; height 4.8962 Å).

Hence in spite of the improvement in reactivity due to the increase in specific surface area and fineness, there is still scope for a considerable increase in the efficacy of these hydrated limes. For example, when used as whitewash, hydrated lime with a specific surface area greater than 35 m²/g has better adhesion to a glass plate than conventional hydrated limes, as demonstrated by a simple stripping test using adhesive films. Yet even though the residual area of the film of carbonated lime which stays on the glass plate is 35% for conventional lime and 62% for limes with a large specific surface area (>35 m²/g), the adhesion is not total, and is capable of much further improvement.

The same is true for the treatment of residual gases from incineration of household waste. Neutralization of the acid gases containing high levels of HCl and SO₂ is performed by dry injection of pulverized hydrated lime. To keep within concentration limits for HCl and SO2, it is necessary to use largely excessive quantities of reagent in relation to the stoichiometry of the acid gas neutralization reactions.

With conventional hydrated lime the quantities of hydrated lime required are three to four times higher than stoichiometric and from two to three times higher with limes with a large specific surface area, as witnessed by the composition shown below of residues from purification of incineration fumes from household waste (RPIFHW):

| | Ca(OH)2 | | |
|---|---|---|---|
| | Equivalent Per 100 parts | | |
| Residual lime (Ca(OH)₂) content (%) | 17.07 | 17.07 | 34.36 |
| Calcium chloride (CaCl₂) content (%) | 20.54 | 13.69 | 27.56 |
| Calcium sulphate (CaSO₄) content (%) | 2.45 | 1.34 | 2.70 |
| Calcium carbonate (CaCO₃) content (%) | 23.75 | 17.58 | 35.38 |
| Total: | 63.81 | 49.68 | 100.00 |

It is evident that limes with a large specific surface area necessitate a considerable excess amount since the real efficacy, that is to say the percentage of hydrated lime actually used for the neutralization of acid gases (HCl, SO₂), is a only a little more than 30%.

The applicant has discovered that, surprisingly, a still more reactive hydrated lime could be obtained that afforded inter alia greater real efficacy in the treatment of acid gases.

### BRIEF DESCRIPTION OF THE INVENTION

A subject-matter of the invention is calcium and/or magnesium hydroxide particles with very high reactivity characterized in that they exhibit an X-ray diffraction line at d=0.49 nm obtained by the Debye-Scherrer powder method with an intensity below 50% (at least 50% reduction), advantageously below 35% (at least 65% reduction), and preferably below 25% (at least 75% reduction), of the intensity of a traditional hydrated lime with a moisture content of 1.5% and a specific surface area of 15.8 m²/g prepared by simple reaction of ground quicklime with an amount of water corresponding to a water/lime weight ratio of 0.60/1.

Preferably, at least 50% by weight, advantageously at least 75% by weight, and most preferably at least 85% by weight, of the particles has the form of micelles with very poor crystallization.

According to an embodiment, said very high reactive hydroxide particles contain an additive selected from the group consisting of organo polysiloxanes, organo hydrosiloxanes, organo hydropolysiloxanes, methylhydro-siloxanes, methylhydro-polydimethylsiloxanes, polydimethylsiloxanes with at least one silanol group, organic polymers comprising at least one functional group selected from ether functional groups and alcohol functional groups, and mixtures thereof, and whereby the additive is present in said very high reactive hydroxide particles so that the ratio (weight of said additive/weight of the very high reactive hydroxide particles expressed in its oxide form) is greater than 0.0005:1, advantageously less than 0.01:1, preferably comprised between 0.0005:1 and 0.01:1 most preferably between 0.002:1 and 0.005:1.

According to advantageous details of embodiments, at least 50% by weight, advantageously at least 75% by weight, preferably more than 85% by weight of said very high reactive hydroxide particles is made up of platelets with a thickness of less than 150 μm, advantageously less than 100 μm, preferably less than 75 μm.

According to possible embodiment, the very high hydroxide particles of the invention further comprise an agent selected from the group consisting of ethyleneglycol, diethyleneglycol, triethyleneglycol, monoethanolamine, diethanolamine, triethanolamine, and mixtures thereof, the ratio (weight of said agent/weight of the very high reactive hydroxide particles expressed in its oxide form) being comprised between 0.005 and 0.02, advantageously between 0.005 and 0.01.

The very high reactive hydroxide particles of the invention have preferably a free water content of less than 2% by weight, advantageously less than 1.5% by weight, especially less than 1% by weight.

The very high reactive hydroxide particles of the invention can be mixed with one or more other solid materials, such as particles, fibers, beads, etc., for example sand, carbon particles, active carbon particles, glass beads, etc.

The invention relates also to a method for preparing very high reactive hydroxide particles of the invention. Said method is given as preferred embodiment.

Said preferred method comprises at least the following reaction step:
a solid oxide selected from the group consisting of CaO, MgO and mixtures of CaO and MgO is reacted at a temperature below 100° C. with liquid water that is at least 25% saturated with calcium and hydroxyl ions in the presence of an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and whereby the additive is present in said reaction in an amount sufficient so that the ratio (weight of said additive/weight of the said solid oxide) is greater than 0.0005:1, advantageously less than 0.01:1, preferably comprised between 0.0005:1 and 0.01:1, most preferably between 0.002:1 and 0.005:1.

The solid oxide selected from the group consisting of CaO, MgO and mixtures of CaO and MgO is reacted at a temperature below 100° C., advantageously below 95° C. with liquid water that is at least 50%, advantageously at 75% saturated, preferably substantially completely saturated (saturation level between 95% and 100%) or even oversaturated or supersaturated with calcium and hydroxyl ions.

The solid oxide selected from the group consisting of CaO, MgO and mixtures of CaO and MgO is reacted at a temperature below 100° C. with liquid water exhibiting an at least partial saturation with calcium ions and hydroxyl ions and exhibiting a temperature below 35° C., for example comprised between 5° C. and about 30° C.

According to an embodiment, the solid oxide selected from the group consisting of CaO, MgO and mixtures of CaO and MgO is reacted with liquid water that is at least 25% saturated with calcium and hydroxyl ions in the presence of an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof and in which during the reaction of the said solid oxide and liquid water, a maximum reaction temperature occurs, whereby the reaction is controlled so that said maximum reaction temperature is between 80° C. and 95° C.

According to another embodiment, the solid oxide selected from the group consisting of CaO, MgO and mixtures of CaO and MgO is reacted with liquid water that is at least 25% saturated with calcium and hydroxyl ions in the presence of an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and in which during the reaction of at least 50% of the weight of the said solid oxide and liquid water, the reaction is controlled so that the reaction temperature for at least 50% by weight of the solid oxide with liquid water is maintained at a temperature between 80° C. and 95° C.

According to details of embodiment, the said additive is first mixed with the oxide, before reacting the said oxide with the liquid water.

Advantageously, the additive is mixed with the oxide through an operation selected from the group consisting of grinding treatment, milling treatment and combinations thereof.

According to other details of embodiment, the said additive is first mixed to the liquid water, before reacting the said oxide with the said liquid water.

According to another detail of an embodiment, prior reacting the oxide with the liquid water, a first part of the said additive is first mixed with the oxide, while a second part of said additive is mixed to the liquid water, whereby the weight ratio first part of said additive/second part of said additive is comprised between 1:10 and 10:1, for example between 1:5 and 5:1, such as between 1:2 and 2:1.

According to a specific embodiment, the method of the invention comprises at least the following step:
a solid oxide selected from the group consisting of CaO, MgO and mixtures of CaO and MgO is reacted at a temperature below 100° C. with liquid water that is at least 25% saturated with calcium and hydroxyl ions in the presence of at least:
   a first additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, the ratio (weight of said first additive/weight of the solid oxide) being comprised between 0.005 and 0.01, and
   a second additive selected from the group consisting of ethyleneglycol, diethyleneglycol, triethyleneglycol, monoethanolamine, diethanolamine, triethanolamine, and mixtures thereof, the ratio (weight of said second additive/weight of the solid oxide) being comprised between 0.005 and 0.01.

If required, the hydroxide product obtained by reacting the said oxide with water can be dried for reducing the free water content, for example to less than 2% by weight, advantageously to less than 1.5% by weight, preferably to less than 1% by weight. The drying is advantageously operated in a manner known as such preventing or reducing possible carbonatation, such as indirect drying, drying in presence of hot inert gases, etc.

The invention relates also to a process for treating a medium selected from the group consisting of gases, soils, water, sand, liquids and combinations thereof, in which the said medium is contacted with at least very high reactive hydroxide particles selected from the group consisting of calcium hydroxide particles, magnesium hydroxide particles and mixture thereof, whereby said very high reactive hydroxide particles exhibit an X-ray diffraction line at d=0.49 nm obtained by the Debye-Scherrer powder method with an intensity below 50% of the intensity of a traditional hydrated lime with a moisture content of 1.5% and a specific surface area of 15.8 m²/g prepared by simple reaction of ground quicklime with an amount of water corresponding to a water/lime weight ratio of 0.60/1. The very high reactive hydroxide particles used in said process have advantageously one or more characteristics of the very high reactive particles of the invention, as for example disclosed here above.

The invention further relates to a sand-lime brick prepared
by mixing moist silica sand and very high reactive hydroxide particles of the invention, so as to form a moist mixture containing silica and hydroxide particles (and optionally one or more other compounds),
by shaping said moist mixture containing silica and hydroxide particles into a moist brick,
by autoclaving, advantageously under pressure, the moist brick during a sufficient time period, so that the autoclaved brick exhibits a compressive strength of at least 25 N/mm² measured after a period of 7 days at 20° C. following the autoclaving step.

The very high reactive hydroxide particles used in said sand-lime brick have advantageously one or more characteristics of the very high reactive particles of the invention, as for example disclosed here above.

Yet another subject-matter of the invention is the use of calcium and/or magnesium hydroxide particles according to the invention in an application selected among the group consisting of the treatment of gases, stabilization of soils, treatment of water and gases, production of sand-lime materials, treatment of soils, treatment of liquids, in particular treatment of water, mineral paints, ceiling dressings, and masonry mortars.

The claims attached to the present statement give particular features of the invention.

### DESCRIPTION OF EXAMPLES

The applicant discovered that by hydrating CaO and/or MgO at a temperature below 100° C. with an aqueous solution saturated with Ca⁺⁺ and OH⁻ ions (lime water) and using particular additives, it was possible to obtain calcium and/or magnesium hydroxide consisting of very small sized crystals with poor crystallization i.e. in an amorphous state, with very much higher reactivity than hydrated limes obtained by known processes.

The applicant has successfully prepared a calcium hydroxide with very high reactivity by using hydration water saturated with calcium ions and hydroxyl ions in concentrations inversely proportional to the temperature (1.85 g/liter at 0° C.-0.77 g/liter at 100° C.) and by conducting the hydration of the quicklime in the presence of an amount of additive chosen among the polymers: the organo polysiloxanes, organo hydrosiloxanes or hydropolysiloxanes, methylhydro-siloxanes or -polysiloxanes, polydimethylsiloxanes, polydimethylsiloxanes comprising one or more silanol groups, and organic polymers comprising one or more ether and alcohol functional groups, and mixtures thereof, such that the additive: CaO and MgO weight ratio is more than 0.0005:1, but in particular between 0.002:1 and 0.005:1, for example 0.0025:1, 0.003:1 or 0.004:1.

The additive is either added during the grinding of the quicklime or added to the lime water to be used for the hydration reaction.

In the examples, the maximum or peak temperature of the hydration reaction was kept below 100° C. and preferably between 80 and 95° C., to prevent the formation of steam prejudicial to the reactivity of the hydrate.

The lowering of the reaction temperature, or its maintenance within a specific range, was obtained by injecting air or gas (in particular an inert gas, e.g. nitrogen) at ambient temperature at the base of a fluidized bed. The moist calcium hydroxide particles are kept in suspension by the fluidizing air or gas. Monitoring/measurement of temperature is advantageously performed by means of a thermal probe, such

monitoring/measurement of temperature then being used to regulate the flow of reagents (lime water and quicklime) and/or of fluidizing gas, to keep within the desired temperature range.

In the adopted process of preparation, the calcium and/or magnesium oxide was subjected to dry grinding in the course of which the additive(s) were incorporated into the quicklime.

The calcium and/or magnesium hydroxide obtained by the process can if necessary be subjected to drying in order to reduce the moisture content, and/or to grinding and various treatments in order to improve the rheological properties of the powdered hydrated lime, for example to facilitate pneumatic conveying and batching during use e.g. in gas and liquid treatment applications.

By hydrating with lime water saturated with calcium (Ca⁺⁺) and hydroxyl (OH⁻) ions in the presence of organic polymers in the amounts cited above, the applicant has been able to obtain very fine micelles of calcium hydroxide whose average diameter is less than a micron and which are very poorly crystallized or even amorphous, as revealed by examination of the X-ray diffraction lines by the Debye-Scherrer powder method.

The lime of the invention which was prepared in the examples exhibits an amorphous or substantially amorphous structure and the size of the micelles of calcium and or magnesium hydroxide, this hydrated lime possessing very high reactivity and a specific surface area according to the BET method (S. Brunauer, P. H. Emmett and E. Teller, J. Am. Chem. Soc., 60, 309 (1938)) greater than 35 m²/g.

In the preparation examples, it appears that the addition of a solution saturated with calcium and hydroxyl ions in contact with the lime and under the action of the abrupt rise in temperature causes a supersaturation of the medium and rapid formation of large numbers or nuclei or seeds of calcium hydroxides. Without limiting the invention to this possible theory, it also appears that the presence of the additives disrupts and inhibits the growth and structure of the calcium hydroxide nuclei.

The additives used in the process are advantageously additives conducive to the final state of the calcium hydroxide micelles, probably by producing an effect of surface absorption and/or poisoning and/or inhibition of the growth of the nuclei, culminating in a calcium hydroxide that is irregular, poorly crystallized, and in an amorphous or substantially amorphous state, and/or shows small plate thickness, this hydroxide exhibiting a large specific surface area and high, or even very high, reactivity.

The saturation of the slaking water or partial saturation of the slaking water can be carried out by adding some CaO or Ca(OH)₂ to the water.

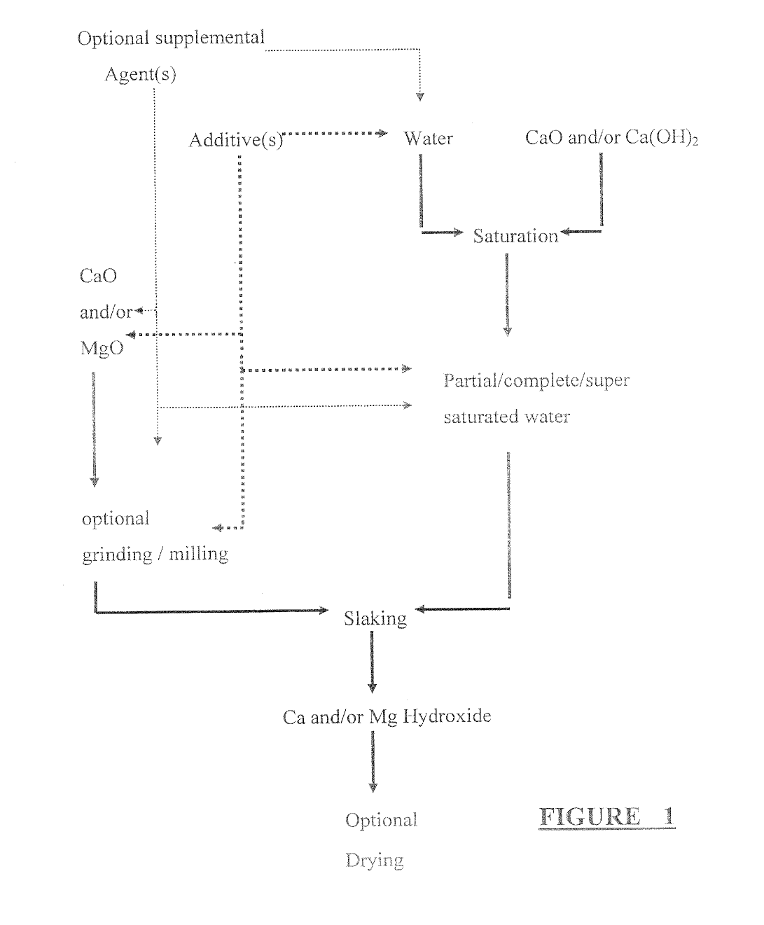

The attached FIG. 1 gives a general flow sheet of a method of the invention.

The additive(s) can be added to the water before its saturation, to the saturated water, to the oxide and/or to the grinding/milling.

The optional agent(s) can be added to the water before its saturation, to the saturated water, to the oxide and/or to the grinding/milling.

Other particulars and details of the invention will emerge from the detailed description of specific examples of preparation and use of hydrated lime according to the invention, these examples being compared with hydrated limes prepared by one or more known processes.

In the examples, comparative tests have been carried out for various applications to demonstrate the exceptional performance of the calcium hydroxide according to the invention.

Preparation of Calcium Hydroxides According to the Invention and not According to the Invention, from the Same Batch of Quicklime.

### Calcium Hydroxide A (Comparative)

A traditional hydrated lime was prepared by reacting ground quicklime with a quantity of water corresponding to a water/lime weight ratio of 0.60/1. The calcium hydroxide thus obtained had a moisture content of 1.5% and a specific surface area of 15.8 m²/g.

### Calcium Hydroxide B (Comparative)

In accordance with Patent EP 0558522 B1, ground quicklime was hydrated with 0.83 part by weight of water in the presence of 0.008 part by weight of diethylene glycol, per part by weight of quicklime.

After drying out the residual moisture of the hydrate, the specific surface area was 39 m²/g.

### Calcium Hydroxide C (Invention)

In accordance with the process according to the invention, ground quicklime was slaked in a fluidized bed (using inert gas) with a quantity of water (lime-saturated at 20° C.) corresponding to a ratio by weight of 0.83 parts of lime water per 1 part by weight of quicklime, in the presence of 0.002 part by weight of polydimethylsiloxane containing a number of hydroxyl functional groups, and of 0.0015 part by weight of diethylene glycol. The maximum temperature of the reaction medium was kept between 85 and 95° C.

The calcium hydroxide had a moisture content of 12%. After drying (by means of inert gas, e.g. nitrogen), the moisture content was reduced to about 1.5% and the specific surface area was approximately 41 m²/g.

Examination of the X-ray diffraction lines by the Debye-Scherrer powder method gave the following results for the various calcium hydroxides that were prepared:

TABLE 1

| | Intensity of lines (d = 0.49 nm) | % reduction from |
|---|---|---|
| Calcium hydroxide | (arbitrary relative units) | intensity A |
| A (comparative) | 60 | |
| B (comparative) | 45 | 25 |
| C (invention) | 15 | 75 |

It is evident from this table that the intensity of the diffraction line at d=0.49 nm characteristic of calcium hydroxide is much lower for hydrated lime C (invention) than for hydrated limes A and B (comparative).

These results show that the degree of crystallization of calcium hydroxide C is much lower than that of hydrated limes A and B.

Owing to the low bulk density values of calcium hydroxide whether in the form of dry hydrated lime (bulk density <500 kg/m³) or in the form of milk of lime with solid concentrations of less then 20% by weight, corresponding to solid bulk densities <200 kg/m³, the lime is generally supplied in the form of powdered quicklime.

In-situ hydration by the process according to the invention makes it possible to reduce transport costs and to obtain a hydrate with very high reactivity and a substantial saving in reagent.

The following use-examples show the advantages of using hydrated lime according the invention in industrial sectors which are major consumers of hydrated limes.

In these use-examples, the three calcium hydroxides (A, B and C) were used in equal concentrations and under identical conditions so that their effectiveness could be compared.

### Use-Example 1

This example concerns the production of sand-lime bricks. Four tests were carried out, three with calcium hydroxides (A, B and C) produced from the same ground quicklime. A fourth test performed with this ground quicklime constitutes the control test and corresponds to the traditional way of using lime

These four tests were carried out in the laboratory with equal concentrations of available CaO in all tests, viz, 7% by weight in relation to the moist sand, and under identical conditions described below:
Mixing moist (8%) silica sand lime in a planetary mill for 5 minutes.
Allowing the mixture to stand at 70° C. for 3 hours.
After readjustment of the water content of the mixture to 6%, forming was effected by pressing in a cylindrical mould 50 mm in diameter and 50 mm high. The quantity of material inserted in the mould corresponded to a material density of the cylindrical prism of 1.8 g/cm³ or, for a volume of 98,175 cm³, 176.715 g of a moist mixture of hydrated lime and sand.
Hardening was effected by autoclaving at a pressure of 10.5 bar for 6 hours.
The moulds were then kept in the ambient air of the laboratory for 7 days, after which their compressive strength was measured.
The values in Table 2 are averages of three measurements for each test.

TABLE 2

| | Compressive strength | Strength in relative |
|---|---|---|
| | N/mm² | values |
| Ground quicklime | 19.3 | 76.6 |
| Calcium hydroxide A | 17.6 | 69.8 |
| Calcium hydroxide B | 21.8 | 86.5 |
| Calcium hydroxide C | 25.2 | 100.0 |

The calcium hydroxide C according to the invention gives a relative strength of 100, against 76.6 for the traditional process of incorporation of quicklime into moist sand, 69.8 for the conventional calcium hydroxide A, and 86.5 for calcium hydroxide B with a large specific surface area. Bearing in mind the linear proportionality between the amount of lime and the strength of sand-lime materials, these very different outcomes offer attractive prospects for economizing on lime to attain the required strength, or for producing sand-lime bricks with high compressive strength.

### Use-Example 2

This example concerns the treatment of acid gases with calcium hydroxide and more particularly the neutralization of the hydrochloric acid content of fumes arising from the incineration of household waste, by injection of hydrated lime.

Laboratory tests were carried out with calcium hydroxides A (comparative), B (comparative) and C (invention) under identical conditions in order to compare their performance in neutralizing gaseous hydrochloric acid.

The tests were performed in a fixed bed. The limes had been rendered into granules with an average diameter of 3 mm, to enable the acid gas to pass freely through the bed. Granulation was performed with an Eirich granulating mixer by intensive mixing at a moisture level of 15%. After treatment, the granules were dried and screened between 4 and 5 mm. The intra- and inter-granular porosity afforded intimate contact between the gas (HCl) and the solid (Ca(OH)₂).

The temperature of the granule bed was maintained at 160° C., corresponding to the average temperature of the fumes from a household waste incinerator.

A gaseous stream of hydrochloric acid with a concentration of 1800 mg HCl/m³ ([HCl]ₒ) and a humidity of 12% was passed through the absorbent bed comprising 9.42 g of calcium hydroxide grains.

The period of contact between the acid gas and the lime was approximately 10 seconds, which corresponds to industrial conditions for dry injection of powder into an incinerator. The total quantity of hydrochloric acid added corresponded to one time the stoichiometric quantity of (Ca(OH)₂).

The quantity of unabsorbed HCl ([HCl]_{f}, being the level of HCl in the gases after their passage through the absorbent bed) was collected in a titrated caustic soda solution.

The levels of dechlorination attained (R), which are presented in Table 3, were calculated as follows:

$$R ( \% ) = \frac{( {[ HCl ]}_{o} - {[ HCl ]}_{f} ) \times 100}{{[ HCl ]}_{o}}$$

TABLE 3

| Calcium hydroxide | Dechlorination yield R (%) |
|---|---|
| A (comparative) | 29.8 |
| B (comparative) | 40.5 |
| C (invention) | 64.6 |

These results show that calcium hydroxide C according to the invention has a much higher capacity for absorption of acid gases than the conventional hydrate A and than calcium hydroxide B.

### Use-Example 3

In the field of stabilization of clayey-oozy soils, the notion of reactivity is underrated. Just as in the manufacture of sand-lime materials, these solid/solid reactions require very high reactivity of the lime in order that losses of reagent can be limited and good yields obtained. Traditionally a quantity of 2% of powdered quicklime is incorporated into the soil at a temperature that is often below 20° C. Hydration of the calcium oxide in contact with the moisture in the soil therefore takes place under conditions highly unfavourable to the production of the reactive calcium hydroxide needed for reactions with argillaceous minerals. Quite apart from the very low temperature of reaction, the H₂O/CaO ratio and the presence of humic acid and mineral salts in the soil will have a very negative effect on the hydration process. For these reasons, only short-term reactions, that is to say those lasting under 2 hours, are taken into consideration. The beneficial long-term effects resulting from the pozzolanic reaction between the limes and the argillaceous materials are disregarded because the reactions are very slow and their effects are not produced until after the freezing period has ended.

The three calcium hydroxides (A, B and C) together with the ground quicklime used for their preparation were intimately mixed with a clayey-oozy soil in a laboratory planetary mixer.

Four batches were made up identical proportions of lime, taking their respective available CaO content into account. These corresponded to a proportion of Ca(OH)₂ of 3%.

After the mixtures had been allowed to stand for 2 hours, the water content was adjusted to 18.2%, corresponding to the optimal water content for compacting. The mixtures were then inserted into 5 cylindrical Proctor test moulds and compacted on both faces with the energy of the modified Proctor. The test specimens were wrapped in polythene film and aluminium paper and stored at 20° C.

The uniaxial compressive strength (Re) was measured after 30, 60 and 120 days. Each result presented in Table 4 is the average of 5 measurements.

TABLE 4

| | Rc (N/mm²) after | | |
|---|---|---|---|
| Type of lime | 30 days | 60 days | 120 days |
| Calcium oxide | 0.56 | 0.76 | 1.08 |
| Calcium hydroxide A | 0.72 | 1.04 | 1.56 |
| Calcium hydroxide B | 1.00 | 1.52 | 2.55 |
| Calcium hydroxide C | 1.56 | 2.24 | 3.60 |

It will be seen from these results that the 120-day strengths obtained with calcium hydroxide C according to the invention are 1.4 times higher than with calcium hydroxide B with large specific surface area, 2.3 times higher than with calcium hydroxide A corresponding to a conventional hydrate, and 3.3 times higher than with the usual process for incorporating quicklime in the soil.

Accordingly there will also be an improvement in short-term effects, namely modifications of the Atterberg limits and of the Proctor compacting curve, and an increase in the CBR value.

As these results are proportional to the amount of lime incorporated in the soil, the effect is a very large saving in the amount of lime required to obtain a given performance through the use of the lime with very high reactivity according to the process according to the invention.

Other particles according to the invention were prepared as indicated for preparation of calcium hydroxide C but using other additives and/or other additive amounts.

| | | Part by weight |
|---|---|---|
| | | of additive |
| Calcium | | per 1 part by |
| hydroxide | Additive(s) | weight of CaO |
| C1 | Polydimethylsiloxane with viscosity below 3 | 0.004 |
| | cSt | |
| C2 | Polydimethylsiloxane with viscosity | 0.003 |
| | between 100 and 1000 cSt | |
| | Diethylene glycol | 0.001 |
| C3 | Silanol - polydimethylsiloxane with viscosity | 0.004 |
| | below 100 cSt | |
| C4 | Dimethylsiloxane - ethylene oxide block | 0.004 |
| | copolymer with viscosity below 100 cSt | |
| C5 | Dimethylsiloxane-propylene oxide block | 0.004 |
| | copolymer with viscosity between 1000 and | |
| | 2000 cSt | |
| C6 | Polydimethylsiloxane (200 cSt) | 0.003 |
| | Triethanolamine | 0.001 |
| C7 | Nonoxynobl-15 | 0.004 |
| C8 | Octoxynol | 0.003 |
| | Diethylene glycol | 0.001 |
| C9 | Silwet ® L77 | 0.003 |

Other additives of the nonionic surfactant type that can be used in the process according to the invention are described in the document US 695601.9

What I claim is:

1. Very high reactive hydroxide particles selected from the group consisting of calcium hydroxide particles, magnesium hydroxide particles and mixture thereof, whereby said very high reactive hydroxide particles exhibit an X-ray diffraction line at d=0.49 nm obtained by the Debye-Scherrer powder method with an intensity below 50% of the intensity of a traditional hydrated lime with a moisture content of 1.5% and a specific surface area of 15.8 m²/g prepared by simple reaction of ground quicklime with an amount of water corresponding to a water/lime weight ratio of 0.60/1.

2. The very high reactive hydroxide particles of claim 1, whereby said very high reactive hydroxide particles exhibit an X-ray diffraction line at d=0.49 nm obtained by the Debye-Scherrer powder method with an intensity below 35% of the intensity of a traditional hydrated lime with a moisture content of 1.5% and a specific surface area of 15.8 m²/g prepared by simple reaction of ground quicklime with an amount of water corresponding to a water/lime weight ratio of 0.60/1.

3. The very high reactive hydroxide particles of claim 1, whereby said very high reactive hydroxide particles exhibit an X-ray diffraction line at d=0.49 nm obtained by the Debye-Scherrer powder method with an intensity equal to or less than approximately 25% of the intensity of a traditional hydrated lime with a moisture content of 1.5% and a specific surface area of 15.8 m²/g prepared by simple reaction of ground quicklime with an amount of water corresponding to a water/lime weight ratio of 0.60/1.

4. The very high reactive hydroxide particles of claim 1, whereby at least 50% by weight of said very high reactive hydroxide particles has the form of micelles with v poor crystallisation pattern.

5. The very high reactive hydroxide particles of claim 1, whereby at least 75% by weight of said very high reactive hydroxide particles has the form of micelles with very poor crystallisation pattern.

6. The very high reactive hydroxide particles of claim 1, whereby at least 85% by weight of said very high reactive hydroxide particles has the form of micelles with very poor crystallisation pattern.

7. The very high reactive hydroxide particles of claim 1, whereby said very high reactive hydroxide particles contain an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and whereby the additive is present in said very high reactive hydroxide particles so that the ratio (weight of said additive/weight of the very high reactive hydroxide particles expressed in its oxide form) is greater than 0.0005:1.

8. The very high reactive hydroxide particles of claim 1, whereby said very high reactive hydroxide particles contain an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and whereby the additive is present in said very high reactive hydroxide particles so that the ratio (weight of said additive/weight of the very high reactive hydroxide particles expressed in its oxide form) is less than 0.01:1.

9. The very high reactive hydroxide particles of claim 1, whereby said very high reactive hydroxide particles contain an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and whereby the additive is present in said very high reactive hydroxide particles so that the ratio (weight of said additive/weight of the very high reactive hydroxide particles expressed in its oxide form) is comprised between 0.0005:1 and 0.01:1.

10. The very high reactive hydroxide particles of claim 1 whereby said very high reactive hydroxide particles contain an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and whereby the additive is present in said very high reactive hydroxide particles so that the ratio (weight of said additive/weight of the very high reactive hydroxide particles expressed in its oxide form) is comprised between 0.002:1 and 0.005:1.

11. The very high reactive hydroxide particles of claim 1, whereby at least 50% by weight of said very high reactive hydroxide particles is made up of platelets with a thickness of less than 150 μm.

12. The very high reactive hydroxide particles of claim 1, whereby at least 50% by weight of said very high reactive hydroxide particles is made up platelets with a thickness of less than 100 μm.

13. The very high reactive hydroxide particles of claim 1, which further comprise an agent selected from the group consisting of ethyleneglycol, diethyleneglycol, triethyleneglycol, monoethanolamine, diethanolamine, triethanolamine, and mixtures thereof, the ratio (weight of said agent/weight of the very high reactive hydroxide particles expressed in its oxide form) being comprised between 0.005 and 0.01.

14. The very high reactive hydroxide particles of claim 1, which have a free water content of less than 2% by weight.

15. A method for preparing very high reactive hydroxide particles selected from the group consisting of calcium hydroxide particles, magnesium hydroxide particles and mixture thereof, whereby said very high reactive hydroxide particles exhibit an X-ray diffraction line at d=0.49 nm obtained by the Debye-Scherrer powder method with an intensity below 50% of the intensity of a traditional hydrated lime with a moisture content of 1.5% and a specific surface area of 15.8 m²/g prepared by simple reaction of ground quicklime with an amount of water corresponding to a water/lime weight ratio of 0.60/1,
said method comprising at least the following reaction step:
a solid oxide selected from the group consisting of CaO, MgO and mixtures of CaO and MgO is reacted at a temperature below 100° C. with liquid water that is at least 25% saturated with calcium and hydroxyl ions in the presence of an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and whereby the additive is present in said reaction in an amount sufficient so that the ratio (weight of said additive/weight of the said solid oxide) is greater than 0.0005:1.

16. The method of claim 15, in which the solid oxide selected from the group consisting of CaO, MgO and mixtures of CaO and MgO is reacted at a temperature below 100° C. with liquid water that is at least 50% saturated with calcium and hydroxyl ions.

17. The method of claim 15, in which the solid oxide selected from the group consisting of CaO, MgO and mixtures of CaO and MgO is reacted at a temperature below 100° C. with liquid water that is at least 75% saturated with calcium and hydroxyl ions.

18. The method of claim 15, in which the solid oxide selected from the group consisting of CaO, MgO and mixtures of CaO and MgO is reacted at a temperature below 100° C. with liquid water that is saturated with calcium and hydroxyl ions to a level at least comprised between 95% and 100%.

19. The method of claim 15, in which the solid oxide selected from the group consisting of CaO, MgO and mixtures of CaO and MgO is reacted at a temperature below 100° C. with liquid water that is supersaturated with ions selected from the group consisting of calcium ions, hydroxyl ions and mixtures thereof.

20. The method of claim 15, in which the solid oxide selected from the group consisting of CaO, MgO and mixtures of CaO and MgO is reacted at a temperature below 100° C. with liquid water exhibiting an at least partial saturation with calcium ions and hydroxyl ions and a temperature below 35° C.

21. The method of claim 15, in which the solid oxide selected from the group 100° C. of CaO, MgO and mixtures of CaO and MgO is reacted at a temperature below 100° C. with liquid water that is at least 25% saturated with calcium and hydroxyl ions in the presence of an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and whereby the additive is present in said reaction in an amount sufficient so that the ratio (weight of said additive/weight of the solid oxide) is comprised between 0.001:1 and 0.01:1.

22. The method of claim 15, in which the solid oxide selected from the group consisting of CaO, MgO and mixtures of CaO and MgO is reacted at a temperature below 100° C. with liquid water that is at least 25% saturated with calcium and hydroxyl ions in the presence of an additive selected from the group consisting of organo polysiloxanes, organo hydrosiloxanes, organo hydropolysiloxanes, methylhydro-methylhydro-polysiloxanes, polydimethylsiloxanes, polydimethylsiloxanes with at least one silanol group, organic polymers comprising at least one functional group selected from ether functional groups and alcohol functional groups, and mixtures thereof, and whereby the additive is present in said reaction in an amount sufficient so that the ratio (weight of said additive/weight of the solid oxide) is comprised between 0.002:1 and 0.005:1.

23. The method of claim 15, in which the solid oxide selected from the group consisting of CaO, MgO and mixtures of CaO and MgO is reacted with liquid water that is at least 25% saturated with calcium and hydroxyl ions in the presence of an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organ is polymers comprising at least one functional group selected from ether functional groups and alcohol functional groups, and mixtures thereof and in which during the reaction of the said solid oxide and liquid water, a maximum reaction temperature occurs, whereby the reaction is controlled so that said maximum reaction temperature is between 80° C. and 95° C.

24. The method of claim 15, in which the solid oxide selected from the group consisting of CaO, MgO and mixtures of CaO and MgO is reacted with liquid water that is at least 25% saturated with calcium and hydroxyl ions in the presence of an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and in which during the reaction of at least 50% of the weight of the said solid oxide and liquid water, the reaction is controlled so that the reaction temperature for at least 50% by weight of the solid oxide with liquid water is maintained at a temperature between 80° C. and 95° C.

25. The method of claim 15, in which the said additive is first mixed with the oxide, before reacting the said oxide with the liquid water.

26. The method of claim 25, in which the additive is mixed with the oxide through an operation selected from the group consisting of grinding treatment, milling treatment and combinations thereof.

27. The method of claim 15, in which said additive is first mixed to the liquid water, before reacting the said oxide with the said liquid water.

28. The method of claim 15, which, prior reacting oxide with the liquid water, a first part of the said additive is first mixed with the oxide, while a second part of said additive is mixed to the liquid water, whereby the weight ratio first part of said additive/second part of said additive is comprised between 1:10 and 10:1.

29. The method of claim 15, which comprises at least the following step:
a solid oxide selected from the group consisting of CaO, MgO and mixtures of CaO and MgO is reacted at a temperature below 100° C. with liquid water that is at least 25% saturated with calcium and hydroxyl ions in the presence of at least
a first additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, the ratio (weight of said first additive/weight of the solid oxide) being comprised between 0.005 and 0.01, and
a second additive selected from the group consisting of ethyleneglycol, diethyleneglycol, triethyleneglycol, monoethanolamine, diethanolamine, triethanolamine, and mixtures thereof, the ratio (weight of said second additive/weight of the solid oxide) being comprised between 0.005 and 0.01.

30. The method of claim 15, which comprises at least the following steps:
a solid oxide selected from the group consisting of CaO, MgO and mixtures of CaO and MgO is reacted at a temperature below 100° C. with liquid water that is at least 25% saturated with calcium and hydroxyl ions in the presence of an additive selected from the group consisting of organo polysiloxanes, organo hydrosiloxanes, organo hydropolysiloxanes, methylhydro-siloxanes, methylhydro-polysiloxanes, polydimethylsiloxanes, polydimethylsiloxanes with at least one silanol group, organic polymers comprising at least one functional group selected from ether functional groups and alcohol functional groups, and mixtures thereof, and whereby the additive is present in said reaction in an amount sufficient so that the ratio (weight of said additive/weight of the said solid oxide) is greater than 0.0005:1, whereby a hydroxide product is prepared, and
the hydroxide product is dried so as to obtain very high reactive hydroxide particles with a free water content of less than 2% by weight.

31. A process for treating a medium selected from the group consisting of gases, soils, water, sand, liquids and combinations thereof, in which the said medium is contacted with at least very high reactive hydroxide particles selected from the group consisting of calcium hydroxide particles, magnesium hydroxide particles and mixture thereof, whereby said very high reactive hydroxide particles exhibit an X-ray diffraction line at d=0.49 nm obtained by the Debye-Scherrer powder method with an intensity below 50% of the intensity of a traditional hydrated lime with a moisture content of 1.5% and a specific surface area of 15.8 m²/g prepared by simple reaction of ground quicklime with an amount of water corresponding to a water/lime weight ratio of 0.60/1.

32. A sand-lime brick prepared by mixing moist silica sand and very high reactive hydroxide particles selected from the group consisting of calcium hydroxide particles, magnesium hydroxide particles and mixture thereof, whereby said very high reactive hydroxide particles exhibit an X-ray diffraction line at d=0.49 nm obtained by the Debye-Scherrer powder method with an intensity below 50% of the intensity of a traditional hydrated lime with a moisture content of 1.5% and a specific surface area of 15.8 m²/g prepared by simple reaction of ground quicklime with an amount of water corresponding to a water/lime weight ratio of 0.60/1, so as to form a moist mixture containing silica and hydroxide particles,
by shaping said moist mixture containing silica and hydroxide particles into a moist brick,
by autoclaving the moist brick during a sufficient time period, so that the autoclaved brick exhibits a compressive strength of at least 25 N/mm² measured after a period of 7 days at 20° C. following the autoclaving step.
